(19) United States
(12) Patent Application Publication
(10) Pub. No.: US 2021/0306829 A1
(43) Pub. Date: Sep. 30, 2021

(54) METHOD, DEVICE, AND SYSTEM FOR TRANSMITTING SYSTEM INFORMATION BETWEEN INTERNET-OF-VEHICLES DEVICES

(71) Applicant: BEIJING XIAOMI MOBILE SOFTWARE CO., LTD., Beijing (CN)

(72) Inventors: Yang LIU, Beijing (CN); Qun ZHAO, Beijing (CN)

(73) Assignee: BEIJING XIAOMI MOBILE SOFTWARE CO., LTD., Beijing (CN)

(21) Appl. No.: 17/262,197

(22) PCT Filed: Jul. 26, 2018
(86) PCT No.: PCT/CN2018/097252

§ 371 Date: Jan. 21, 2021

(51) Int. Cl. H04W 4/46; H04W 48/10

(52) U.S. Cl. CPC H04W 4/46; H04W 48/10

(57) ABSTRACT

A method, device, and system are provided for transmitting system information between Internet-of-Vehicle devices. The method includes a first Internet-of-Vehicle device sending a physical broadcast channel. The physical broadcast channel may include first system information. The first system information may include an extension indicator. The extension indicator may be configured to indicate whether there is second system information outside the physical broadcast channel. The method may also include a second Internet-of-vehicle device receiving the physical broadcast channel. The method may further include the second Internet-of-vehicle device receiving the second system information sent by the first Internet-of-vehicle device in response to the extension indicator indicating that the second system information is outside the physical broadcast channel.

### CROSS-REFERENCE TO RELATED APPLICATION

This application is the US national phase application of International Application No. PCT/CN2018/097252, filed on Jul. 26, 2018, the entire contents of which are incorporated herein by reference for all purposes.

### TECHNICAL FIELD

The present disclosure relates to a field of wireless communication technologies, and more particularly to a method, an apparatus, and a system for transmitting system information between Internet-of-vehicle devices.

### BACKGROUND

The Internet-of-vehicle is a new development direction of automobile technologies, which combines navigation and positioning, wireless communication and remote sensing technologies.

In the related art, synchronization and information transmission are performed between Internet-of-vehicle devices by broadcasting system information. For example, one Internet-of-vehicle device may send a synchronization signal and system information of the Internet-of-vehicle device in a broadcast way. Another Internet-of-vehicle device performs signal synchronization by the synchronization signal, and communicates with the Internet-of-vehicle device based on the system information after receiving the synchronization signal and the system information.

### SUMMARY

The present disclosure provides a method for transmitting system information between Internet-of-vehicle devices.

According to a first aspect of the embodiments of the present disclosure, there is provided a method for transmitting system information between Internet-of-vehicle devices. The method includes a first Internet-of-vehicle device sending a physical broadcast channel. The physical broadcast channel carries first system information. The first system information includes an extension indicator. The extension indicator being configured to indicate whether there is second system information outside the physical broadcast channel. The method may further include a second Internet-of-vehicle device receiving the physical broadcast channel. The second Internet-of-vehicle device may receive, in response to the extension indicator indicating that the second system information is outside the physical broadcast channel, the second system information sent by the first Internet-of-vehicle device.

According to a second aspect of the embodiments of the present disclosure, there is provided a method for transmitting system information between Internet-of-vehicle devices. The method may include receiving a physical broadcast channel sent by a first Internet-of-vehicle device. The physical broadcast channel carries first system information. The first system information may include an extension indicator. The extension indicator may be configured to indicate whether there is second system information outside the physical broadcast channel. The method may further include extracting the extension indicator. The method may also include receiving the second system information sent by the first Internet-of-vehicle device in response to the extension indicator indicating that the second system information is outside the physical broadcast channel.

According to a third aspect of the embodiments of the present disclosure, there is provided a method for transmitting system information between Internet-of-vehicle devices. The method may include generating an extension indicator. The extension indicator may be configured to indicate whether second system information is outside the physical broadcast channel. The method may further include generating first system information containing the extension indicator. The method may also include sending a physical broadcast channel carrying the first system information, such that a second Internet-of-vehicle device receiving the physical broadcast channel receives the second system information in response to that the extension indicator indicates that there is the second system information outside the physical broadcast channel.

According to a fourth aspect of embodiments of the present disclosure, there is provided a computing. The device includes: one or more processors and a tangible non-transitory computer-readable storage medium. The tangible non-transitory computer-readable storage medium may be configured to store a plurality of instructions executable by the one or more processors. The one or more processors are configured to receive a physical broadcast channel sent by a first Internet-of-vehicle device. The physical broadcast channel carrying first system information. The first system information may include an extension indicator. The extension indicator may be configured to indicate whether there is second system information outside the physical broadcast channel. The one or more processors may further be configured to extract the extension indicator. The one or more processors may also be configured to receive the second system information sent by the first Internet-of-vehicle device in response to the extension indicator indicating that the second system information is outside the physical broadcast channel.

According to a fifth aspect of embodiments of the present disclosure, there is provided a computing device. The device may include a processor and a tangible non-transitory computer-readable storage medium. The tangible non-transitory computer-readable storage medium may be configured to store instructions executable by the one or more processors. The one or more processors may be configured to generate an extension indicator. The extension indicator may be configured to indicate whether there is second system information outside the physical broadcast channel. The one or more processors may also be configured to generate first system information containing the extension indicator. The one or more processors may further be configured to send a physical broadcast channel carrying the first system information, such that a second Internet-of-vehicle device receiving the physical broadcast channel receives the second system information in response to the extension indicator indicating that the second system information is outside the physical broadcast channel.

According to a sixth aspect of embodiments of the present disclosure, there is provided a non-transitory computer readable storage medium. The computer readable storage medium includes executable instructions. A processor in a second Internet-of-vehicle device is configured to call the executable instructions to implement the method for transmitting the system information between the Internet-of-vehicle devices according to the second aspect.

According to a seventh aspect of embodiments of the present disclosure, there is provided a non-transitory computer readable storage medium. The computer readable storage medium includes executable instructions. A processor in a first Internet-of-vehicle device is configured to call the executable instructions to implement the method for transmitting the system information between the Internet-of-vehicle devices according to the third aspect.

It is to be understood that both the foregoing general description and the following detailed description are exemplary only, and are not restrictive of the present disclosure.

### BRIEF DESCRIPTION OF THE DRAWINGS

The accompanying drawings, which are incorporated in and constitute a part of this specification, illustrate embodiments consistent with the present disclosure, and serve to explain the principle of the present disclosure together with the specification.

FIG. 1 is a schematic diagram illustrating an environment where a method for transmitting system information between Internet-of-vehicle devices is implemented according to a part of exemplary embodiments.

FIG. 2 is a flow chart illustrating a method for transmitting system information between Internet-of-vehicle devices according to an exemplary embodiment.

FIG. 3 is a flow chart illustrating a method for transmitting system information between Internet-of-vehicle devices according to an exemplary embodiment.

FIG. 4 is a flow chart illustrating a method for transmitting system information between Internet-of-vehicle devices according to an exemplary embodiment.

FIG. 5 is a flow chart illustrating a method for transmitting system information between Internet-of-vehicle devices according to an exemplary embodiment.

FIG. 6 is a schematic diagram illustrating first system information related to an exemplary embodiment illustrated in FIG. 5.

FIG. 7 is a block diagram illustrating an apparatus for transmitting system information between Internet-of-vehicle devices according to an exemplary embodiment.

FIG. 8 is a block diagram illustrating an apparatus for transmitting system information between Internet-of-vehicle devices according to an exemplary embodiment.

FIG. 9 is a block diagram illustrating an Internet-of-vehicle device according to an exemplary embodiment.

### DETAILED DESCRIPTION

Exemplary embodiments will be described in detail herein, examples of which are illustrated in the accompanying drawings. When the following description refers to the accompanying drawings, the same or similar elements may be denoted by the same numerals in different accompanying drawings, unless otherwise indicated. The implementations described in the following exemplary embodiments do not represent all implementations consistent with the present disclosure. Instead, they are merely examples of apparatuses and methods consistent with aspects of the present disclosure as detailed in the appended claims.

It should be understood that, as used herein, “several” means one or more, and “multiple” means two or more. The term “and/or” describes an association relationship between associated objects, and means that there may be three kinds of relationships. For example, A and/or B may mean that A exists alone, A and B exist at the same time, and B exists alone. The character “/” generally indicates that the associated objects are in an “or” relationship.

Internet-of-vehicle communication is also referred as V2x (vehicle to everything) communication, which includes V2V (vehicle to vehicle) communication, V2I (vehicle to infrastructure) communication and V2P (vehicle to pedestrian) communication. The Internet-of-vehicle technology may effectively improve traffic safety, improve traffic efficiency and enrich travel experience of people by the V2V communication, the V2I communication and the V2P communication.

An existing cellular communication technology is utilized to support the Internet-of-vehicle communication, thereby effectively utilizing an existing base station deployment, reducing a device overhead, and facilitating to provide a service with a QoS (Quality of Service) guarantee, and meeting a requirement of an Internet-of-vehicle service. Therefore, Rel-14/15 of an LTE (long term evolution) technology provides a support of a cellular network for the Internet-of-vehicle communication V2x, i.e., C-V2x (cellular based V2x). In the C-V2x technology, a communication between a vehicle-mounted device and other device may be transferred via the base station and a core network, that is, a communication link between a terminal device and the base station in the existing cellular network is utilized for the communication (uplink/downlink communication). In another possible implementation, the vehicle-mounted device and the other device may also communicate directly via a direct link between the devices, for example, via Sidelink. Compared with the uplink/downlink communication, the side link communication has characteristics such as a short delay and a low overhead, which is suitable for direct communication between the vehicle-mounted device and other peripheral device with a close geographical position to the vehicle-mounted device.

The V2x Sidelink communication in the LTE may support some V2x applications in a basic safety aspect, such as exchanging a BSM (basic safety message) such as a CAM (cooperative awareness message) or a DENM (decentralized environmental notification message) for conducting speech broadcast communication. Recently, with the development of technologies such as automatic driving, in order to support a new V2x business, a new requirement is put forward for a performance of the V2x technology. Utilizing a 5G NR (new radio) technology to support a new V2x communication service and scenario is planned as an important content of Rel16 by a 3GPP (3rd generation partnership project). A 3GPP working group establishes some new business requirements that the V2x communication needs to meet, including vehicles platooning, extended sensors, advanced driving, and remote driving. Generally, the NR V2x Sidelink needs to provide a higher communication rate, a shorter communication delay and a more reliable communication quality.

Generally, a V2x device may perform communication with other devices via the Sidelink by means of a vehicle-mounted GNSS (global navigation satellite system) such as a GPS or a Beidou, or taking a synchronization signal broadcast by the base station as a synchronization reference signal of the V2x device to ensure synchronization between a sender and a receiver. However, considering universality of a V2x Internet-of-vehicle application scenario, even when the V2x device is located outside a coverage of a base station of the cellular network and may not reliably receive a GNSS signal (for example, located at a mountain and a desert road), the V2x devices need to reliably communicate with each other via the Sidelink. Therefore, the LTE V2x supports synchronization via the Sidelink (direct link), that is, one V2x device may complete the synchronization between the V2x devices by receiving a synchronization signal broadcast by other V2x device. In the LTE V2x, a system message of the V2x communication is broadcast via both the PSBCH (physical Sidelink broadcast channel) and the synchronization signal. The broadcast content contains some information related to the synchronization and a system configuration.

The 3GPP launches research on the NR V2X in R16. The Sidelink of the V2x communication is mainly for opportunistic localized communication between the devices, and it needs to be ensured via broadcasting that the devices within a communication range have a same synchronization and frame structure understanding. Therefore, the broadcast system information is less than that of the 5G NR. Therefore, when a transmission mode for the system information of the 5G NR is directly used in the NR V2X, redundancy of the system information and waste of communication resources of the NR V2X may be caused, and the communication efficiency of the NR V2X is affected.

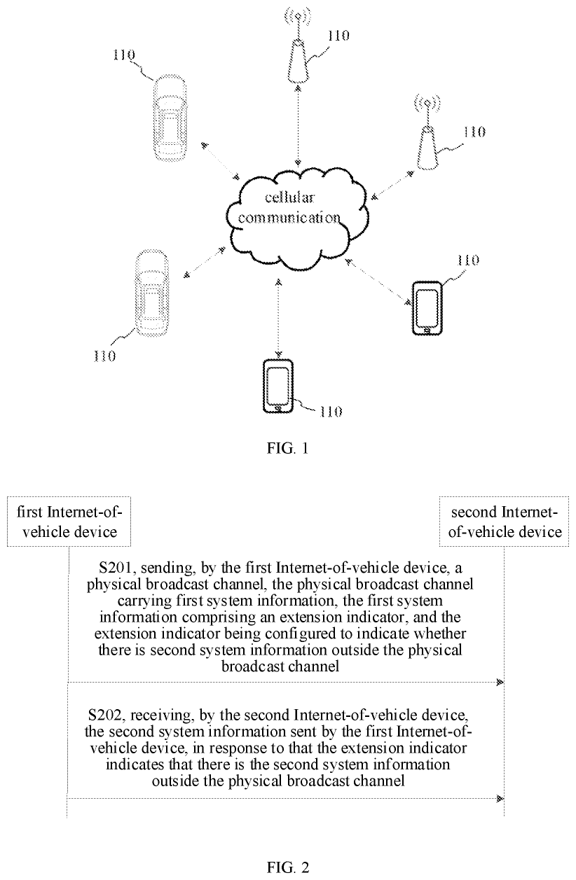

FIG. 1 is a schematic diagram illustrating an environment where a method for transmitting system information between Internet-of-vehicle devices is implemented according to a part of exemplary embodiments. As illustrated in FIG. 1, the environment may include several Internet-of-vehicle devices 110.

The Internet-of-vehicle device 110 is a wireless communication device supporting the V2x technology. For example, the Internet-of-vehicle device 110 may support the cellular mobile communication technology, such as the 4th generation mobile communication (4G) technology or 5G technology. The Internet-of-vehicle device 110 may also support the next generation of mobile communication technology following the 5G technology.

For example, the Internet-of-vehicle device 110 may be a vehicle-mounted communication device, such as an onboard computer with a wireless communication function, or a wireless communication device externally connected to the onboard computer.

Alternatively, the Internet-of-vehicle device 110 may also be a roadside device, such as a street lamp, a signal lamp or other roadside device with the wireless communication function.

Alternatively, the Internet-of-vehicle device 110 may also be a user terminal device such as a mobile phone (or referred as a “cellular” phone), and a computer with a mobile terminal such as a portable, pocket-sized, hand-held, computer built-in or vehicle-mounted mobile device, which may be such as a station (STA), a subscriber unit, a subscriber station, a mobile station, a mobile, a remote station, an access point, a remote terminal, an access terminal, a user terminal, a user agent, a user device, or a user equipment (UE). For example, the Internet-of-vehicle device 110 may be a mobile terminal such as a smart phone, a tablet computer, or an e-book reader, or a smart wearable device such as smart glasses, a smart watch or a smart bracelet.

FIG. 2 is a flow chart illustrating a method for transmitting system information between Internet-of-vehicle devices according to an exemplary embodiment. As illustrated in FIG. 2, the method for transmitting the system information between the Internet-of-vehicle devices is applied to the environment illustrated in FIG. 1. The method may include the followings.

At block 201, a first Internet-of-vehicle device sends a physical broadcast channel. The physical broadcast channel carries first system information. The first system information includes an extension indicator. The extension indicator is configured to indicate whether there is second system information outside the physical broadcast channel. A second Internet-of-vehicle device receives the physical broadcast channel.

At block 202, the second Internet-of-vehicle device receives the second system information sent by the first Internet-of-vehicle device in response to that the extension indicator indicates that there is the second system information outside the physical broadcast channel.

In a 5G new radio system, system information is sent in a hierarchical manner, that is, a sender sends the PBCH (physical broadcast channel) firstly. The PBCH contains an MIB (master information block). The subsequent hierarchical transmission includes an SIB (system information block) 1, an RMSI (remaining minimum system information), and other SIB and OSI (open system interconnection) information. The PBCH contains necessary information for decoding the RMSI. The RMSI and the OSI respectively contain access information and other necessary system information. Therefore, an SSB (synchronous signal/ PBCH block) in the 5G new radio system occupies more time-frequency resources, which generally needs to occupy 4 or more OFDM (orthogonal frequency division multiplexing) symbols, and also needs a higher bandwidth in a time-frequency domain.

With the solution provided by embodiments of the present disclosure, in the V2x, the physical broadcast channel only contains basic system information (i.e., the first system information). The sender (i.e., the first Internet-of-vehicle device) does not necessarily send system information other than the basic system information, and indicates by the extension indicator in the first system information whether the system information (i.e., the second system information) other than the first system information is sent. The second Internet-of-vehicle device receives the second system information only when the received extension indicator is configured to indicate that there is the second system information.

In conclusion, with the solution illustrated by embodiments of the present disclosure, the first system information sent by the first Internet-of-vehicle device to the second Internet-of-vehicle device includes the extension indicator. The second Internet-of-vehicle device receives the second system information only when the extension indicator indicates that there is the second system information outside the physical broadcast channel. That is, additional system information may be transmitted between the two Internet-of-vehicle devices only when the system information other than the basic system information needs to be sent, thereby greatly simplifying the structure of the system information, saving time-frequency resources for transmitting the system information and improving the efficiency of transmitting the system information.

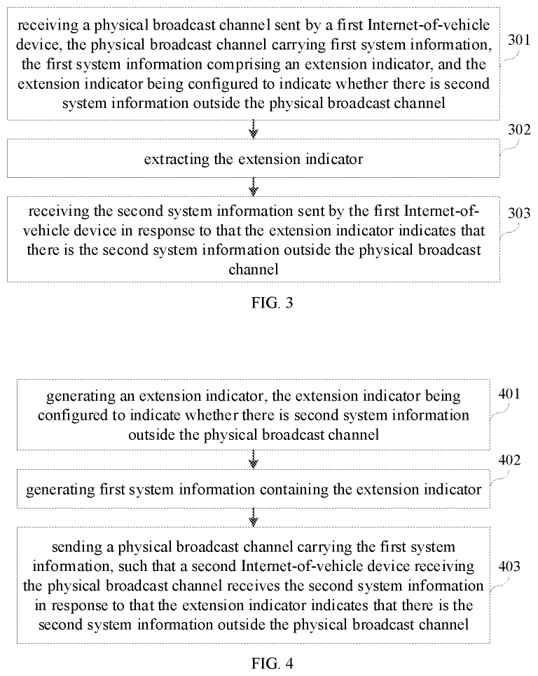

FIG. 3 is a flow chart illustrating a method for transmitting system information between Internet-of-vehicle devices according to an exemplary embodiment. The method may be executed by the second Internet-of-vehicle device in the embodiment illustrated in FIG. 2. The method may include the followings.

At block 301, a physical broadcast channel sent by a first Internet-of-vehicle device is received. The physical broadcast channel carries first system information. The first system information includes an extension indicator. The extension indicator is configured to indicate whether there is second system information outside the physical broadcast channel.

At block 302, the extension indicator is extracted.

At block 303, the second system information sent by the first Internet-of-vehicle device is received in response to that the extension indicator indicates that there is the second system information outside the physical broadcast channel.

Alternatively, receiving the second system information sent by the first Internet-of-vehicle device in response to that the extension indicator indicates that there is the second system information outside the physical broadcast channel includes: obtaining extension configuration information contained in the first system information in response to that the extension indicator indicates that there is the second system information outside the physical broadcast channel, the extension configuration information being configured to indicate a resource position of the second system information; and receiving the second system information sent by the first Internet-of-vehicle device based on the resource position of the second system information.

Alternatively, the second system information includes resource pool information. The resource pool information is configured to indicate a time-frequency position of a communication resource for communicating with the first Internet-of-vehicle device.

Alternatively, receiving the physical broadcast channel sent by the first Internet-of-vehicle device includes: receiving the physical broadcast channel sent by the first Internet-of-vehicle device via Sidelink.

Alternatively, the first system information further includes at least one of: network coverage information, a system frame number, system frame instructions, position information of a demodulation reference signal, and time indication information of a synchronous broadcast block.

In conclusion, with the solution illustrated by embodiments of the present disclosure, the first system information sent by the first Internet-of-vehicle device to the second Internet-of-vehicle device includes the extension indicator. The second Internet-of-vehicle device receives the second system information only when the extension indicator indicates that there is the second system information outside the physical broadcast channel. That is, additional system information may be transmitted between the two Internet-of-vehicle devices only when the system information other than the basic system information needs to be sent, thereby greatly simplifying the structure of the system information, saving time-frequency resources for transmitting the system information and improving the efficiency of transmitting the system information.

FIG. 4 is a flow chart illustrating a method for transmitting system information between Internet-of-vehicle devices according to an exemplary embodiment. The method may be executed by the first Internet-of-vehicle device in the embodiment illustrated in FIG. 2. The method may include the followings.

At block 401, an extension indicator is generated. The extension indicator is configured to indicate whether there is second system information outside the physical broadcast channel.

At block 402, first system information containing the extension indicator is generated.

At block 403, a physical broadcast channel carrying the first system information is sent, such that a second Internet-of-vehicle device receiving the physical broadcast channel receives the second system information in response to that the extension indicator indicates that there is the second system information outside the physical broadcast channel.

Alternatively, generating the first system information containing the extension indicator includes: generating the first system information containing the extension indicator and extension configuration information in response to that there is the second system information outside the physical broadcast channel. The extension configuration information is configured to indicate a resource position of the second system information.

Alternatively, the method further includes: sending the second system information based on the resource position of the second system information.

In conclusion, with the solution illustrated by embodiments of the present disclosure, the first system information sent by the first Internet-of-vehicle device to the second Internet-of-vehicle device includes the extension indicator. The second Internet-of-vehicle device receives the second system information only when the extension indicator indicates that there is the second system information outside the physical broadcast channel. That is, additional system information may be transmitted between the two Internet-of-vehicle devices only when the system information other than the basic system information needs to be sent, thereby greatly simplifying the structure of the system information, saving time-frequency resources for transmitting the system information and improving the efficiency of transmitting the system information.

FIG. 5 is a flow chart illustrating a method for transmitting system information between Internet-of-vehicle devices according to an exemplary embodiment. As illustrated in FIG. 5, the method for transmitting the system information between the Internet-of-vehicle devices is applied to the environment illustrated in FIG. 1. The method may include the following.

At block 501, a first Internet-of-vehicle device generates an extension indicator. The extension indicator is configured to indicate whether there is second system information outside a physical broadcast channel.

The first Internet-of-vehicle device may send the physical broadcast channel via Sidelink. The Sidelink is a kind of direct link between devices. Accordingly, a second Internet-of-vehicle device may receive the physical broadcast channel sent by the first Internet-of-vehicle device via the Sidelink.

In embodiments of the present disclosure, system information of the V2X communication may be sent mainly in a single-level way, but optionally, in a multi-level way, that is, the system only defines one basic physical broadcast channel in the Sidelink. In the Sidelink, the basic physical broadcast channel may also be called the PSBCH. The basic physical broadcast channel contains basic system information (i.e., the first system information) required for V2X communication.

Before sending the physical broadcast channel, the first Internet-of-vehicle device firstly determines whether the second system information needs to be sent outside the physical broadcast channel in addition to the first system information carried in the physical broadcast channel, and determines whether the second system information needs to be sent outside the physical broadcast channel, to generate the extension indicator.

The extension indicator may be a field that may take different values. For example, a value range of the extension indicator is 0 or 1. When the first Internet-of-vehicle device determines that the second system information does not need to be sent outside the physical broadcast channel, the value of the extension indicator is set to 0, which indicates that there is no second system information outside the physical broadcast channel. On the contrary, when the second Internet-of-vehicle device determines that the second system information needs to be sent outside the physical broadcast channel, the value of the extension indicator is set to 1, which indicates that there is the second system information outside the physical broadcast channel.

Alternatively, the first Internet-of-vehicle device further generates extension configuration information in response to that the extension indicator indicates that there is the second system information outside the physical broadcast channel. The extension configuration information is configured to indicate a resource position of the second system information.

The resource position indicated by the extension configuration information is a resource position other than a resource position occupied by the physical broadcast channel. For example, a time-frequency resource indicated by the resource position may be a resource after the time-frequency resource occupied by the physical broadcast channel in time domain.

At block 502, the first Internet-of-vehicle device generates first system information including the extension indicator.

Alternatively, the first Internet-of-vehicle device generates the first system information including the extension indicator and the extension configuration information in response to that there is the second system information outside the physical broadcast channel. The extension configuration information is configured to indicate the resource position of the second system information.

In embodiments of the present disclosure, the first Internet-of-vehicle device may generate the first system information including the extension indicator with the value of 0 in response to that the second system information does not need to be sent outside the physical broadcast channel. The first system information may not include the extension configuration information.

The first Internet-of-vehicle device may generate the first system information including the extension indicator with the value of 1 in response to that the second system information needs to be sent outside the physical broadcast channel. The first system information includes the extension configuration information.

In another possible implementation, whether or not the second system information needs to be sent outside the physical broadcast channel, the first Internet-of-vehicle device may generate the first system information including the extension indicator and the extension configuration information. A value of the extension configuration information is a null when there is no need to send the second system information outside the physical broadcast channel (for example, the value of the extension indicator is 0).

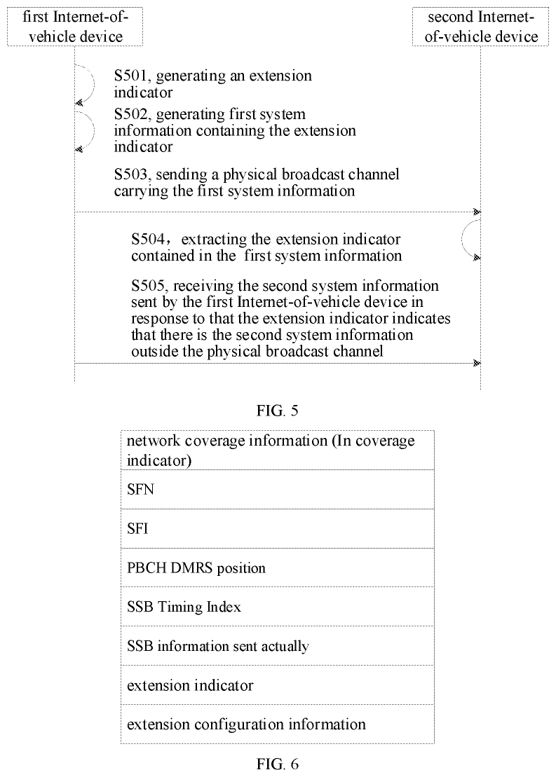

Alternatively, please refer to FIG. 6, which is a schematic diagram illustrating first system information related to embodiments of the present disclosure. As illustrated in FIG. 6, in addition to the extension indicator and the extension configuration information, the first system information may also include at least one of: network coverage information (In coverage indicator), system frame number (SFN), system frame instructions (SFI), position information of a demodulation reference signal of the physical broadcast channel (PBCH DMRS position), time indication information of a synchronous broadcast block (SSB timing index), and SSB information actually transmitted.

The network coverage information may be configured to indicate whether the first Internet-of-vehicle device is currently located in a coverage area of a cellular network, and related information of the cellular network currently covering the first Internet-of-vehicle device, such as a cell identifier.

The system frame number is contained in a system message and broadcast on the physical broadcast channel for paging groups and scheduling system information.

The system frame instruction is configured to indicate a frame structure of a current message. The 5G NR system supports a flexible frame structure. For example, a 5G frame structure may be composed of a fixed part and a flexible part. The fixed part is the same as the LTE, and a length of a radio frame and a length of a subframe are fixed, which facilitates synchronization of the time slot and the frame structure in an LTE and NR co-deployment mode, simplifies cell search and frequency measurement. The time slot and the character length in the flexible part may be flexibly defined based on a subcarrier interval. In other words, the frame structure in the 5G NR system is not fixed. In embodiments of the present disclosure, the first system information may carry the system frame instruction for indicating the frame structure of the current message, such that the receiver may quickly determine the frame structure of the current message.

The position information of the demodulation reference signal of the physical broadcast channel indicates a time-frequency position of the demodulation reference signal.

The time indication information of the synchronous broadcast block is configured to indicate a timing index of the synchronous broadcast block.

The SSB information actually transmitted is configured to indicate a part of a system-defined SSB to which the transmitted SSB belongs. Since the PBCH in the 5G NR system supports beam transmission, and the number of beams actually sent may be different, the SSB information actually sent needs to be given in the PBCH.

At block 503, the first Internet-of-vehicle device sends the physical broadcast channel carrying the first system information, and the second Internet-of-vehicle device receives the physical broadcast channel.

In embodiments of the present disclosure, the first Internet-of-vehicle device may send the physical broadcast channel carrying the first system information via a wireless signal based on a preset transmission period, and the second Internet-of-vehicle device detects the wireless signal and receives the physical broadcast channel.

At block 504, the second Internet-of-vehicle device extracts the extension indicator contained in the first system information in the physical broadcast channel.

The second Internet-of-vehicle device detects the wireless signal, performs signal synchronization based on a synchronization signal in the wireless signal, analyzes the first system information in the physical broadcast channel, and extracts the extension indicator in the first system information.

The extension indicator may be set in a specified field of the first system information. The second Internet-of-vehicle device extracts the extension indicator from the specified field of the first system information after parsing the first system information.

At block 505, the first Internet-of-vehicle device sends the second system information, and the second Internet-of-vehicle device receives the second system information sent by the first Internet-of-vehicle device, in response to that the extension indicator indicates that there is the second system information outside the physical broadcast channel.

The first Internet-of-vehicle device may send the second system information based on the resource position indicated by the extension configuration information when the second system information needs to be sent outside the physical broadcast channel. Accordingly, the first Internet-of-vehicle device may not send the second system information when there is no need to send the second system information outside the physical broadcast channel.

The second Internet-of-vehicle device may determine whether there is the second system information based on the value of the extension indicator after obtaining the extension indicator. In response to that it is determined that there is the second system information (for example, the value of the extension indicator is 1), the second Internet-of-vehicle device may further obtain the extension configuration information in the first system information and receive the second system information sent by the first Internet-of-vehicle device based on the resource position indicated by the extension configuration information.

The second Internet-of-vehicle device does not need to perform the step of receiving the second system information when the second Internet-of-vehicle device obtains the extension indicator and determines that there is no second system information based on the value of the extension indicator (for example, the value of the extension indicator is 0).

Alternatively, the second system information includes resource pool information. The resource pool information is configured to indicate a time-frequency position of a communication resource for communicating with the first Internet-of-vehicle device.

In embodiments of the present disclosure, the first Internet-of-vehicle device may put the resource pool information into the second system information of the basic system information to improve the flexibility of the system.

In conclusion, with the solution illustrated by embodiments of the present disclosure, the first system information sent by the first Internet-of-vehicle device to the second Internet-of-vehicle device includes the extension indicator. The second Internet-of-vehicle device receives the second system information only when the extension indicator indicates that there is the second system information outside the physical broadcast channel. That is, additional system information may be transmitted between the two Internet-of-vehicle devices only when the system information other than the basic system information needs to be sent, thereby greatly simplifying the structure of the system information, saving time-frequency resources for transmitting the system information and improving the efficiency of transmitting the system information.

The following is apparatus embodiments of the present disclosure, which may be configured to execute the method embodiments of the present disclosure. For details not disclosed in the apparatus embodiments of the present disclosure, please refer to the method embodiments of the present disclosure.

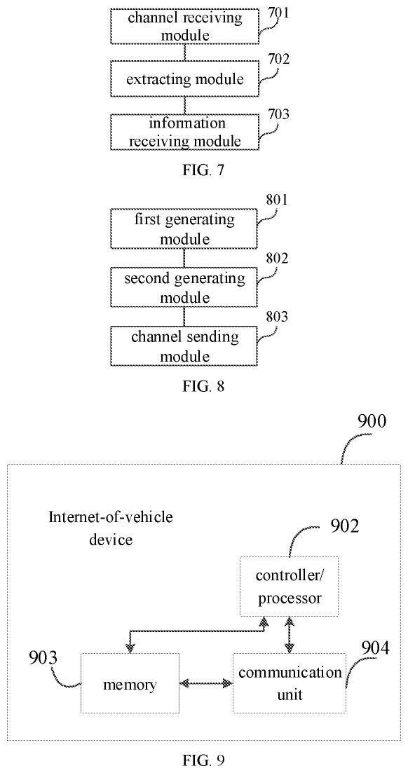

FIG. 7 is a block diagram illustrating an apparatus for transmitting system information between Internet-of-vehicle devices according to an exemplary embodiment. As illustrated in FIG. 7, the apparatus for transmitting the system information between the Internet-of-vehicle devices may be implemented as all or a part of the Internet-of-vehicle device in the environment illustrated in FIG. 1 by hardware or a combination of software and hardware, to perform the actions performed by the second Internet-of-vehicle device in any of embodiments illustrated in FIG. 2, FIG. 3 or FIG. 5. The apparatus for transmitting the system information between the Internet-of-vehicle devices may include: a channel receiving module 701, an extracting module 702, and an information receiving module 703.

The channel receiving module 701 is configured to receive a physical broadcast channel sent by a first Internet-of-vehicle device. The physical broadcast channel carries first system information. The first system information includes an extension indicator. The extension indicator is configured to indicate whether there is second system information outside the physical broadcast channel.

The extracting module 702 is configured to extract the extension indicator.

The information receiving module 703 is configured to receive the second system information sent by the first Internet-of-vehicle device in response to that the extension indicator indicates that there is the second system information outside the physical broadcast channel.

Alternatively, the information receiving module 703 is configured to: obtain extension configuration information contained in the first system information in response to that the extension indicator indicates that there is the second system information outside the physical broadcast channel, the extension configuration information being configured to indicate a resource position of the second system information; and receive the second system information sent by the first Internet-of-vehicle device based on the resource position of the second system information.

Alternatively, the second system information includes resource pool information. The resource pool information is configured to indicate a time-frequency position of a communication resource for communicating with the first Internet-of-vehicle device.

Alternatively, the channel receiving module 701 is configured to: receive the physical broadcast channel sent by the first Internet-of-vehicle device via Sidelink.

Alternatively, the first system information further includes at least one of: network coverage information, a system frame number, system frame instructions, position information of a demodulation reference signal, and time indication information of a synchronous broadcast block.

In conclusion, with the solution illustrated by embodiments of the present disclosure, the first system information sent by the first Internet-of-vehicle device to the second Internet-of-vehicle device includes the extension indicator. The second Internet-of-vehicle device receives the second system information only when the extension indicator indicates that there is the second system information outside the physical broadcast channel. That is, additional system information may be transmitted between the two Internet-of-vehicle devices only when system information other than the basic system information needs to be sent, thereby greatly simplifying the structure of the system information, saving time-frequency resources for transmitting the system information and improving the efficiency of transmitting the system information.

FIG. 8 is a block diagram illustrating an apparatus for transmitting system information between Internet-of-vehicle devices according to an exemplary embodiment. As illustrated in FIG. 8, the apparatus for transmitting the system information between the Internet-of-vehicle devices may be implemented as all or a part of the Internet-of-vehicle device in the environment illustrated in FIG. 1 by hardware or a combination of software and hardware, to perform the action performed by the first Internet-of-vehicle device in any of embodiments illustrated in FIG. 2, FIG. 4 or FIG. 5. The apparatus for transmitting the system information between the Internet-of-vehicle devices may include: a first generating module 801, a second generating module 802, and a channel sending module 803.

The first generating module 801 is configured generate an extension indicator. The extension indicator is configured to indicate whether there is second system information outside the physical broadcast channel.

The second generating module 802 is configured generate first system information containing the extension indicator.

The channel sending module 803 is configured to send a physical broadcast channel carrying the first system information, such that a second Internet-of-vehicle device receiving the physical broadcast channel receives the second system information in response to that the extension indicator indicates that there is the second system information outside the physical broadcast channel.

Alternatively, the second generating module 802 is configured to: generate the first system information containing the extension indicator and extension configuration information in response to that there is the second system information outside the physical broadcast channel. The extension configuration information is configured to indicate a resource position of the second system information.

Alternatively, the apparatus further includes an information sending module configured to send the second system information based on the resource position of the second system information.

In conclusion, with the solution illustrated by embodiments of the present disclosure, the first system information sent by the first Internet-of-vehicle device to the second Internet-of-vehicle device includes the extension indicator. The second Internet-of-vehicle device receives the second system information only when the extension indicator indicates that there is the second system information outside the physical broadcast channel. That is, additional system information may be transmitted between the two Internet-of-vehicle devices only when system information other than the basic system information needs to be sent, thereby greatly simplifying the structure of the system information, saving time-frequency resources for transmitting the system information and improving the efficiency of transmitting the system information.

An exemplary embodiment of the present disclosure also provides a system for transmitting system information between Internet-of-vehicle devices. The system includes: a first Internet-of-vehicle device and a second Internet-of-vehicle device.

The first Internet-of-vehicle device includes the apparatus for transmitting the system information between the Internet-of-vehicle devices according to the embodiment illustrated in FIG. 8.

The second Internet-of-vehicle device includes the apparatus for transmitting the system information between the Internet-of-vehicle devices according to the embodiment illustrated in FIG. 7.

It should be noted that, the division of the above functional modules is taken only as an example for description when the apparatus provided in the above embodiments realizes its functions. In an actual application, the above functions may be assigned to different functional modules based on an actual requirement, that is, a content structure of the apparatus may be divided into different functional modules to complete all or a part of the functions described above.

With regard to the apparatus in the above embodiments, the specific manner in which each module performs operations has been described in detail in the embodiments related to the method, which is not elaborated here.

An exemplary embodiment of the present disclosure provides a device for transmitting system information between Internet-of-vehicle devices. The device may implement all or a part of actions performed by the second Internet-of-vehicle device in embodiments illustrated in FIG. 2, FIG. 3, or FIG. 5 of the present disclosure. The device for transmitting the system information between the Internet-of-vehicle devices includes: a processor and a memory. The memory is configured to store instructions executable by the processor.

The processor is configured to: receive a physical broadcast channel sent by a first Internet-of-vehicle device, the physical broadcast channel carrying first system information, the first system information including an extension indicator, and the extension indicator being configured to indicate whether there is second system information outside the physical broadcast channel; extract the extension indicator; and receive the second system information sent by the first Internet-of-vehicle device in response to that the extension indicator indicates that there is the second system information outside the physical broadcast channel.

Alternatively, receiving the second system information sent by the first Internet-of-vehicle device in response to that the extension indicator indicates that there is the second system information outside the physical broadcast channel includes: obtaining extension configuration information contained in the first system information in response to that the extension indicator indicates that there is the second system information outside the physical broadcast channel, the extension configuration information being configured to indicate a resource position of the second system information; and receiving the second system information sent by the first Internet-of-vehicle device based on the resource position of the second system information.

Alternatively, the second system information includes resource pool information. The resource pool information is configured to indicate a time-frequency position of a communication resource for communicating with the first Internet-of-vehicle device.

Alternatively, receiving the physical broadcast channel sent by the first Internet-of-vehicle device includes: receiving the physical broadcast channel sent by the first Internet-of-vehicle device via Sidelink.

Alternatively, the first system information further includes at least one of: network coverage information, a system frame number, system frame instructions, position information of a demodulation reference signal, and time indication information of a synchronous broadcast block.

An exemplary embodiment of the present disclosure provides a device for transmitting system information between Internet-of-vehicle devices. The device may implement all or a part of actions performed by the first Internet-of-vehicle device in embodiments illustrated in FIG. 2, FIG. 4, or FIG. 5 of the present disclosure. The device for transmitting the system information between the Internet-of-vehicle devices includes: a processor and a memory. The memory is configured to store instructions executable by the processor.

The processor is configured to: generate an extension indicator, the extension indicator being configured to indicate whether there is second system information outside the physical broadcast channel; generate first system information containing the extension indicator; and send a physical broadcast channel carrying the first system information, such that a second Internet-of-vehicle device receiving the physical broadcast channel receives the second system information in response to that the extension indicator indicates that there is the second system information outside the physical broadcast channel.

Alternatively, generating the first system information containing the extension indicator includes: generating the first system information containing the extension indicator and extension configuration information in response to that there is the second system information outside the physical broadcast channel, the extension configuration information being configured to indicate a resource position of the second system information.

Alternatively, the processor is further configured to: send the second system information based on the resource position of the second system information.

The above mainly takes the Internet-of-vehicle device as an example to introduce the solution provided by embodiments of the present disclosure. It may be understood that, in order to implement the above functions, the Internet-of-vehicle device includes corresponding hardware structures and/or software modules for executing respective functions. In combination with modules and algorithm steps of each example described in embodiments of the present disclosure, embodiments of the present disclosure may be implemented in the form of hardware or a combination of hardware and computer software. That a certain function is executed by the hardware or computer software drives the hardware depends on a specific application and a design constraint of the technical solution. The skilled in the art may use different methods to implement the described functions for each specific application, but this implementation should not be considered as exceeding the scope of the technical solution of embodiments of the present disclosure.

FIG. 9 is a block diagram illustrating an Internet-of-vehicle device according to an exemplary embodiment.

The Internet-of-vehicle device 900 includes a communication unit 904 and a processor 902. The processor 902 may also be a controller, which is represented as a “controller/processor 902” in FIG. 9. The communication unit 904 is configured to support the Internet-of-vehicle device to communicate with other network entities (such as other Internet-of-vehicle device).

Further, the Internet-of-vehicle device 900 may further include a memory 903. The memory 903 is configured to store program codes and data of the Internet-of-vehicle device 900.

It may be understood that, FIG. 9 only illustrates a simplified design of the Internet-of-vehicle device 900. In an actual application, the Internet-of-vehicle device 900 may include any number of processors, controllers, memories, communication units, etc. All the Internet-of-vehicle devices that may implement embodiments of the present disclosure are within the protection scope of embodiments of the present disclosure.

The skilled in the art should realize that, the functions described in embodiments of the present disclosure may be realized by hardware, software, firmware or any combination thereof in one or more of the above examples. These functions may be stored in a computer readable medium or transmitted as one or more instructions or codes on the computer readable medium when implemented in the software. The computer readable medium includes a computer storage medium and a communication medium. The communication medium includes any medium that facilitates to transmit a computer program from one place to another. The storage medium may be any available medium that may be accessed by a general purpose or special purpose computer.

Embodiments of the present disclosure also provide a computer storage medium for storing computer software instructions used by the first Internet-of-vehicle device or the second Internet-of-vehicle device, which contains a program designed for performing the method for transmitting the system information between the Internet-of-vehicle devices.

Other implementations of the present disclosure will be apparent to the skilled in the art from consideration of the specification and practice of the present disclosure disclosed here. This present disclosure is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It should be understood that the present disclosure is not limited to the exaction construction that has been described above and illustrated in the accompanying drawings, and that various modifications and changes may be made without departing from the scope thereof. The scope of the present disclosure only be limited by the appended claims.

1. A method for transmitting system information between Internet-of-vehicle devices, comprising:
sending, by a first Internet-of-vehicle device, a physical broadcast channel, wherein the physical broadcast channel carries first system information, wherein the first system information comprises an extension indicator which is configured to indicate whether there is second system information outside the physical broadcast channel;
receiving, by a second Internet-of-vehicle device, the physical broadcast channel; and
receiving, by the second Internet-of-vehicle device and in response to the extension indicator indicating that the second system information is outside the physical broadcast channel, the second system information sent by the first Internet-of-vehicle device.

2. A method for transmitting system information between Internet-of-vehicle devices, comprising:
receiving a physical broadcast channel sent by a first Internet-of-vehicle device, wherein the physical broadcast channel carries first system information, wherein the first system information comprises an extension indicator which is configured to indicate whether there is second system information outside the physical broadcast channel;
extracting the extension indicator; and
receiving the second system information sent by the first Internet-of-vehicle device in response to the extension indicator indicating that the second system information is outside the physical broadcast channel.

3. The method of claim 2, wherein receiving, in response to the extension indicator indicating that the second system information is outside the physical broadcast channel, the second system information sent by the first Internet-of-vehicle device comprises:
obtaining extension configuration information contained in the first system information in response to that-the extension indicator indicating that there is the second system information is outside the physical broadcast channel, wherein the extension configuration information is configured to indicate a resource position of the second system information; and
receiving the second system information sent by the first Internet-of-vehicle device based on the resource position of the second system information.

4. The method of claim 2, wherein the second system information comprises resource pool information, wherein the resource pool information is configured to indicate a time-frequency position of a communication resource for communicating with the first Internet-of-vehicle device.

5. The method of claim 2, wherein receiving the physical broadcast channel sent by the first Internet-of-vehicle device comprises:
receiving the physical broadcast channel sent by the first Internet-of-vehicle device via a side link.

6. The method of claim 2, wherein the first system information further comprises at least one of: network coverage information, a system frame number, system frame instructions, position information of a demodulation reference signal, and time indication information of a synchronous broadcast block.

7. A method for transmitting system information between Internet-of-vehicle devices, comprising:
generating an extension indicator, wherein the extension indicator is configured to indicate whether second system information is outside a physical broadcast channel;
generating first system information containing the extension indicator; and
sending the physical broadcast channel carrying the first system information, such that a second Internet-of-vehicle device receiving the physical broadcast channel receives the second system information in response to that the extension indicator indicates that there is the second system information outside the physical broadcast channel.

8. The method of claim 7, wherein generating the first system information containing the extension indicator comprises:
generating the first system information containing the extension indicator and extension configuration information in response to that there is the second system information outside the physical broadcast channel, the extension configuration information is configured to indicate a resource position of the second system information.

9. The method of claim 8, further comprising:
sending the second system information based on the resource position of the second system information.

10-18. (canceled)

19. A computing device, comprising:
one or more processors; and
a tangible non-transitory computer-readable storage medium, configured to store a plurality of instructions executable by the one or more processors,
wherein the one or more processors are configured to:
receive a physical broadcast channel sent by a first Internet-of-vehicle device, the physical broadcast channel carrying first system information, the first system information comprises an extension indicator, and the extension indicator is configured to indicate whether there is second system information outside the physical broadcast channel;
extract the extension indicator; and
receive the second system information sent by the first Internet-of-vehicle device in response to the extension indicator indicating that there is the second system information is outside the physical broadcast channel.

20. A computing device, comprising:
one or more processors; and
a tangible non-transitory computer-readable storage medium, configured to store a plurality of instructions executable by the one or more processors,
wherein the one or more processors are configured to:
generate an extension indicator, wherein the extension indicator is configured to indicate whether second system information is outside a physical broadcast channel;
generate first system information containing the extension indicator; and
send the physical broadcast channel carrying the first system information, such that a second Internet-of-vehicle device receiving the physical broadcast channel receives the second system information in response to the extension indicator indicating that the second system information is outside the physical broadcast channel.

21. A non-transitory computer readable storage medium, wherein the non-transitory computer readable storage medium comprises executable instructions, and one or more processors in a second Internet-of-vehicle device are configured to implement the method for transmitting the system information between the Internet-of-vehicle devices according to claim 2 by executing the executable instructions.

22. A non-transitory computer readable storage medium, wherein the non-transitory computer readable storage medium comprises executable instructions, and one or more processors in a first Internet-of-vehicle device are configured to implement the method for transmitting the system information between the Internet-of-vehicle devices according to claim 7 by executing the executable instructions.
